(19) United States
(12) Patent Application Publication
(10) Pub. No.: US 2009/0165057 A1
(43) Pub. Date: Jun. 25, 2009

(54) CONCURRENT PROGRAM CONTENT PROCESSING APPARATUS, SYSTEMS, AND METHODS

(76) Inventors: Kerry Philip Miller, El Segundo, CA (US); Gary W. Dalmadge, Broomfield, CO (US); Stephen Bartlett, Dallas, TX (US)

Correspondence Address: SEED INTELLECTUAL PROPERTY LAW GROUP PLLC, 701 FIFTH AVENUE, SUITE 5400, SEATTLE, WA, 98104, US

(21) Appl. No.: 11/961,875

(22) Filed: Dec. 20, 2007

(51) Int. Cl. H04N 7/20

(52) U.S. Cl. 725/68

(57) ABSTRACT

Various embodiments concurrently process program content corresponding to multiple concurrently communicated programs. One embodiment provides a program content transporter that receives via a content stream selector a multiplexed signal that contains a plurality of program content portions that each correspond to one of a plurality of programs, and concurrently presents the program content portion corresponding to a first program of the plurality of programs and records the received program content portion corresponding to a second program of the plurality of programs.

### TECHNICAL FIELD

The technical field relates to concurrent program content processing systems and methods for audio/video/data content providers and, more particularly, to apparatus, systems and methods for concurrently presenting and recording program content received via a single carrier signal.

### BRIEF SUMMARY

In one embodiment, a system that concurrently processes multiple distinct programs communicated via a single carrier signal is provided. The system includes a receiving device comprising a tuner operable to receive a multiplexed signal via a satellite network that communicates digital video programming, the multiplexed signal comprising a plurality of program content portions, each program content portion corresponding to one of a plurality of programs, and a program content transporter that is communicatively coupled to the tuner. The program content transporter is operable to determine a first and second program of the plurality of programs, and to concurrently present the program content portion corresponding to the first program on a display device communicatively coupled to the receiving device and record the received program content portion corresponding to the second program.

In another embodiment, a method to concurrently process multiple distinct programs communicated via a single carrier signal is provided. The method includes receiving via a content stream selector in a receiving device a multiplexed signal that contains a plurality of program content portions that each correspond to one of a plurality of programs, the multiplexed signal received by the receiving device via a broadcast network that communicates digital video programming, presenting a first program content portion of the received program content portions, the first program content portion corresponding to a first program of the plurality of programs, and recording a second program content portion of the received program content portions, the second program content portion corresponding to a second program of the plurality of programs, wherein the presenting of the first program content portion and the recording of the second program content portion are performed concurrently.

In another embodiment, a computer-readable medium is provided, the computer-readable medium including contents that enable a computing system to concurrently process multiple distinct programs communicated via single carrier signal, by performing a method such as the above.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating an example communication system in which embodiments of a program content transporter may be implemented.

FIG. 2 is a block diagram illustrating example functional elements of an example embodiment.

FIG. 3 is a block diagram illustrating multiple programs multiplexed on multiple distinct carrier signals in an example embodiment.

FIG. 4 is a block diagram illustrating an example embodiment of a program content transporter implemented in a receiving device.

FIG. 5 is a flow diagram of an example program content transporter process provided by an example embodiment.

### DETAILED DESCRIPTION

A. Communication System Overview

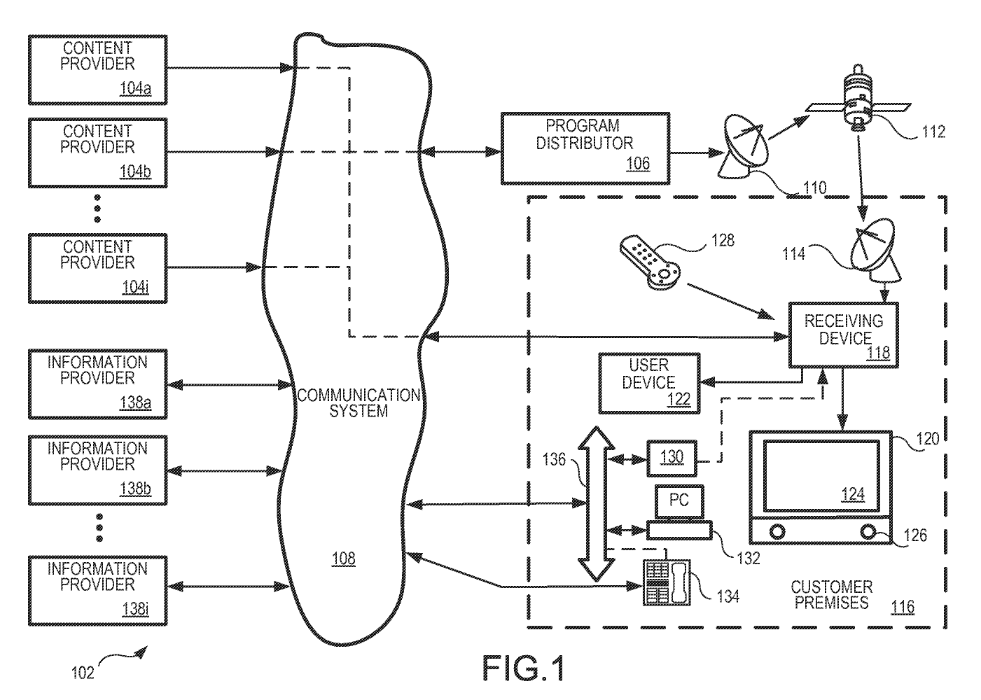

FIG. 1 is an overview block diagram illustrating an example communication system 102 in which embodiments of a program content transporter (“PCT”) may be implemented. It is to be appreciated that FIG. 1 is just one example of a communications system and that the various embodiments discussed herein are not limited to such exemplary systems. Communication system 102 can include a variety of communication systems and can use a variety of communication media including, but not limited to, satellite wireless media.

Audio/Video/Data service providers, such as, but not limited to, Television service providers, provide their customers a multitude of audio/video and/or data programming (hereafter, collectively and/or exclusively “programming”). Such programming is often provided by use of a receiving device 118 (FIG. 1) communicatively coupled to a presentation device 120 configured to receive the programming.

Receiving device 118 interconnects to one or more communications media or sources (such as a cable head-end, satellite antenna, telephone company switch, Ethernet portal, off-air antenna, or the like) that provide the programming. The receiving device 118 commonly receives a plurality of programming by way of the communications media or sources described in greater detail below. Based upon selection by the user, the receiving device 118 processes and communicates the selected programming to the one or more presentation devices 120.

For convenience, the receiving device 118 may be interchangeably referred to as a “television converter,” “receiver,” “set-top box,” “television receiving device,” “television receiver,” “television recording device,” “satellite set-top box,” “satellite receiver,” “cable set-top box,” “cable receiver,” “media player,” and/or “television tuner.” Accordingly, the receiving device 118 may be any suitable converter device or electronic equipment that is operable to receive programming. Further, the receiving device 118 may itself include user interface devices, such as buttons or switches. In many applications, a remote 128 is operable to control the presentation device 120 and other user devices 122.

Examples of a presentation device 120 include, but are not limited to, a television (TV), a personal computer (PC), a sound system receiver, a digital video recorder (DVR), a compact disk (CD) device, game system, or the like. Presentation devices 120 employ a display 124, one or more speakers, and/or other output devices to communicate video and/or audio content to a user. In many implementations, one or more presentation devices 120 reside in or near a customer's premises 116 and are communicatively coupled, directly or indirectly, to the receiving device 118. Further, the receiving device 118 and the presentation device 120 may be integrated into a single device. Such a single device may have the above-described functionality of the receiving device 118 and the presentation device 120, or may even have additional functionality.

A plurality of content providers 104a-104i provide program content, such as television content or audio content, to a distributor, such as the program distributor 106. Exemplary content providers 104a-104i include television stations which provide local or national television programming, special content providers which provide premium based programming or pay-per-view programming, or radio stations which provide audio programming.

Program content, interchangeably referred to as a program, is communicated to the program distributor 106 from the content providers 104a-104i through suitable communication media, generally illustrated as communication system 108 for convenience. Communication system 108 may include many different types of communication media, now known or later developed. Non-limiting media examples include telephony systems, the Internet, internets, cable systems, fiber optic systems, microwave systems, asynchronous transfer mode (ATM) systems, frame relay systems, digital subscriber line (DSL) systems, radio frequency (RF) systems, and satellite systems. Further, program content communicated from the content providers 104a-104i to the program distributor 106 may be communicated over combinations of media. For example, a television broadcast station may initially communicate program content, via an RF signal or other suitable medium, that is received and then converted into a digital signal suitable for transmission to the program distributor 106 over a fiber optics system. As another nonlimiting example, an audio content provider may communicate audio content via its own satellite system to the program distributor 106.

In at least one embodiment, the received program content is converted by one or more devices (not shown) as necessary at the program distributor 106 into a suitable signal that is communicated (i.e.; “uplinked”) by one or more antennae 110 to one or more satellites 112 (separately illustrated herein from, although considered part of, the communication system 108). It is to be appreciated that the communicated uplink signal may contain a plurality of multiplexed programs. The uplink signal is received by the satellite 112 and then communicated (i.e., “downlinked”) from the satellite 112 in one or more directions, for example, onto a predefined portion of the planet. It is appreciated that the format of the above-described signals are adapted as necessary during the various stages of communication.

A receiver antenna 114 that is within reception range of the downlink signal communicated from satellite 112 receives the above-described downlink signal. A wide variety of receiver antennae 114 are available. Some types of receiver antenna 114 are operable to receive signals from a single satellite 112. Other types of receiver antenna 114 are operable to receive signals from multiple satellites 112 and/or from terrestrial based transmitters.

The receiver antenna 114 can be located at a customer premises 116. Examples of customer premises 116 include a residence, a business, or any other suitable location operable to receive signals from satellite 112. The received signal is communicated, typically over a hard-wire connection, to a receiving device 118. The receiving device 118 is a conversion device that converts, also referred to as formatting, the received signal from antenna 114 into a signal suitable for communication to a presentation device 120 and/or a user device 122. Often, the receiver antenna 114 is of a parabolic shape that may be mounted on the side or roof of a structure. Other antenna configurations can include, but are not limited to, phased arrays, wands, or other dishes. In some embodiments, the receiver antenna 114 may remotely located from the customer premises 116. For example, the antenna 114 may be located on the roof of an apartment building, such that the received signals may be transmitted, after possible recoding, via cable or other mechanisms, such as Wi-Fi, to the customer premises 116.

The received signal communicated from the receiver antenna 114 to the receiving device 118 is a relatively weak signal that is amplified, and processed or formatted, by the receiving device 118. The amplified and processed signal is then communicated from the receiving device 118 to a presentation device 120 in a suitable format, such as a television (TV) or the like, and/or to a user device 122. It is to be appreciated that presentation device 120 may be any suitable device operable to present a program having video information and/or audio information.

User device 122 may be any suitable device that is operable to receive a signal from the receiving device 118, another endpoint device, or from other devices external to the customer premises 116. Additional non-limiting examples of user device 122 include optical media recorders, such as a compact disk (CD) recorder, a digital versatile disc or digital video disc (DVD) recorder, a digital video recorder (DVR), or a personal video recorder (PVR). User device 122 may also include game devices, magnetic tape type recorders, RF transceivers, and personal computers (PCs).

Interface between the receiving device 118 and a user (not shown) may be provided by a hand-held remote device 128. Remote 128 typically communicates with the receiving device 118 using a suitable wireless medium, such as infrared (IR), RF, or the like. Other devices (not shown) may also be communicatively coupled to the receiving device 118 so as to provide user instructions. Non-limiting examples include game device controllers.

The receiving device 118 may receive programming partially from, or entirely from, another source other than the above-described receiver antenna 114. Other embodiments of the receiving device 118 may receive locally broadcast RF signals, or may be coupled to communication system 108 via any suitable medium. Non-limiting examples of medium communicatively coupling the receiving device 118 to communication system 108 include cable, fiber optic, or Internet media.

Customer premises 116 may include other devices which are communicatively coupled to communication system 108 via a suitable media. For example, but not limited to, some customer premises 116 include an optional network 136, or a networked system, to which receiving devices 118, presentation devices 120, and/or a variety of user devices 122 can be coupled, collectively referred to as endpoint devices. Non-limiting examples of network 136 include, but are not limited to, an Ethernet, twisted pair Ethernet, an intranet, a local area network (LAN) system, or the like, One or more endpoint devices, such as PCs, data storage devices, TVs, game systems, sound system receivers, Internet connection devices, digital subscriber loop (DSL) devices, wireless LAN, WiFi, Worldwide Interoperability for Microwave Access (WiMax), or the like, are communicatively coupled to network 136 so that the plurality of endpoint devices are communicatively coupled together. Thus, the network 136 allows the interconnected endpoint devices, and the receiving device 118, to communicate with each other. Alternatively, or in addition, some devices in the customer premises 116 may be directly connected to the communication system 108, such as the telephone 134 which may employ a hardwire connection or an RF signal for coupling to communication system 108.

A plurality of information providers 138a-138i are coupled to communication system 108. Information providers 138a-138i may provide various forms of content and/or services to the various devices residing in the customer premises 116. For example, information provider 138a may provide requested information of interest to PC 132. Information providers 138a-138i may further perform various transactions, such as when a user purchases a product or service via their PC 132.

The above description of the communication system 102 and the customer premises 116, and the various devices therein, is intended as a broad, non-limiting overview of an exemplary environment in which various embodiments of a program content transporter may be implemented. The communication system 102, and the various devices therein, may contain other devices, systems and/or media not specifically described herein.

As noted above, the signal received by the receiving device 118 may include a plurality of multiplexed programs. In particular, a plurality of programs may be communicated as a plurality of program content streams that are multiplexed upon a single carrier signal. Each content stream may comprise a plurality of program content portions each containing video, audio, and/or data corresponding to the program. Program content portions may comprise MPEG (“Motion Picture Experts Group”) packets that contain compressed and/or encrypted video, audio, and/or other data. In addition, program content portions may be encapsulated and/or formatted in other ways, such as by use of other or additional transport, compression, and/or encryption techniques.

A plurality of program content streams may be multiplexed in various ways. For example, two program content streams, corresponding to two distinct programs, may be multiplexed upon a single carrier signal, such that an alternating sequence of program content portions, respectively corresponding to the first and the second program, is communicated via the carrier signal. The number of program content streams that may be communicated via a single carrier signal may be based on the bandwidth capacity provided by the carrier signal and the bandwidth utilization of each of the program content streams. For example, if a single carrier signal provides 30 megabits per second (Mbits/s) capacity, and each program content stream consumes four Mbits/s, then as many as eight program content streams may be communicated via the single carrier signal. Various multiplexing techniques are contemplated, including, but not limited to, time division multiplexing, frequency division multiplexing, code division multiplexing, statistical multiplexing, and the like.

In some instances, it may be desirable to access multiple program content streams concurrently. For example, a user may desire to view a first program and record a second program that are being communicated concurrently by a program distributor 106 to a receiving device 118. In one approach, the receiving device 118 may include at least two tuners, such that the first tuner can be configured to receive a first carrier signal that carries a program content stream corresponding to the first program and the second tuner can be configured to receive a second carrier signal that carries a program content stream corresponding to the second program. Then, the receiving device 118 may concurrently process the two program content streams by, for example, displaying the first program content stream on a presentation device 120 and recording the second program content stream on a user device 122, which may be, for example, a digital video recorder. However, such a multiple tuner approach may be subject to several disadvantages, such as higher manufacturing costs for receiving devices 118, increased power consumption by receiving devices 118, and the like.

Accordingly, the various embodiments disclosed herein, whether used singularly or in combination, may use and/or provide various techniques to facilitate the concurrent utilization of program content communicated via a single carrier signal. The techniques may include receiving via a single content stream selector a multiplexed signal containing multiple distinct programs, and concurrently presenting a first one of the multiple programs and recording a second one of the multiple programs. A content stream selector may comprise, for example, a tuner configured to tune to a particular frequency that is used to carry program content. For example, a receiving device 118 having a single tuner may receive, from a single carrier signal, content portions corresponding to each of the first and the second program. The receiving device 118 may be configured to concurrently process the received content portions by, for example, displaying on the presentation device 120 content portions corresponding to the first program and storing on the user device 122 content portions corresponding to the second program. In addition, in some embodiments, the program distributor 106 may select multiple distinct programs for communication via a single carrier signal based on characteristics of the programs, such as based on programs that are commonly viewed and recorded concurrently. In at least some embodiments, some of the described techniques are performed by a program content transporter (“PCT”), described below.

B. Program Content Transporter Overview

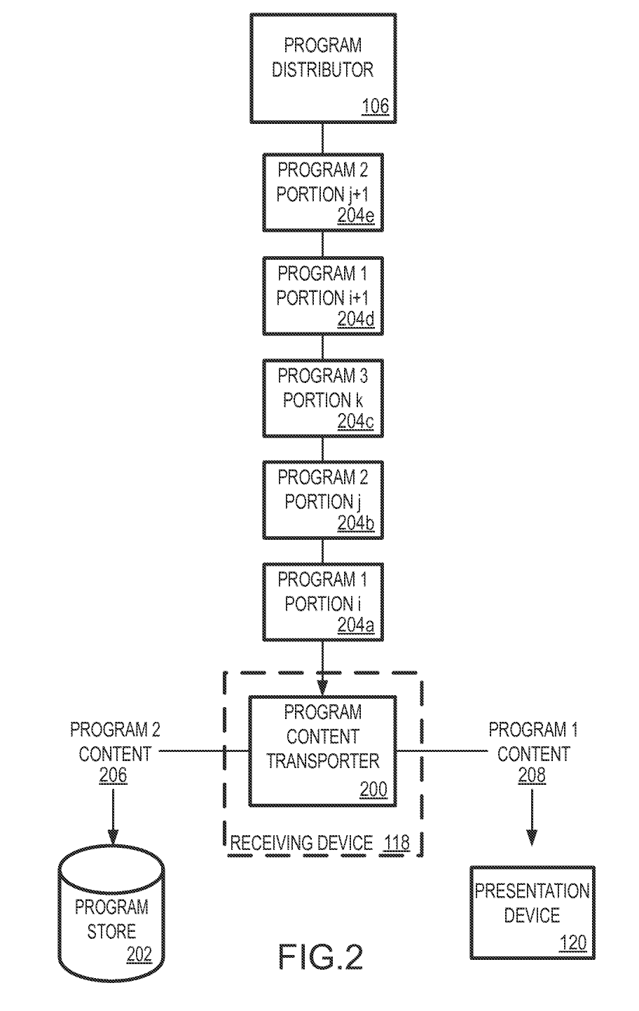

FIG. 2 is a block diagram illustrating example functional elements of an example embodiment. In particular, FIG. 2 shows an example program content transporter (“PCT”) 200. The program content transporter 200 is communicatively coupled to a program distributor 106, a program store 202, and a presentation device 120. The program content transporter 200 may optionally be implemented as part of some other device, such as the illustrated receiving device 118. The program store 202 may comprise a memory, disk, and/or other data storage device. It may be, or be part of, various other kinds of devices, such as the receiving device 118, the presentation device 120, a user device 122, a personal computer 132, a personal media player, and the like.

In one example, the program content transporter 200 facilitates the concurrent presentation and recording of two distinct programs, Program 1 and Program 2. In particular, program distributor 106 concurrently communicates three programs, Program 1, Program 2, and Program 3, to the program content transporter 200 as a series of program content portions 204a-204e. As noted, the program content portions 204a-204e may be multiplexed on a single carrier signal (not shown). In this example, alternating ones of the program content portions 204a-204e correspond respectively to Programs 1-3. Specifically, program content portions 204a and 204d are two consecutive program content portions of Program 1, program content portions 204b and 204e are two consecutive program content portions of Program 2, and program content portion 204c is a program content portion of Program 3.

As the program content transporter 200 receives program content portions, it concurrently communicates those program content portions corresponding to a first program of interest to presentation device 120 and communicates those program content portions corresponding to a second program of interest to program store 202. Here, Program 1 is the first program of interest and Program 2 is the second program of interest. Accordingly, as program content portions corresponding to Program 1, such as program content portions 204a and 204d, are received, they are communicated as program 1 content 208 to the presentation device 120. In addition, as program content portions corresponding to Program 2, such as program content portions 204b and 204e, are received, they are communicated as program 2 content 206 to the program store 202. In some embodiments, the received program content portions may be processed, such as by being decrypted, encrypted, decompressed, formatted, and/or otherwise transformed, prior to being communicated to the presentation device 120 and/or the program store 202.

In one example, program content portions corresponding to programs aside from Program 1 and Program 2 are ignored by the program content transporter 200. However, in other embodiments, the program content transporter 200 may facilitate concurrent utilization of more than two programs of interest. For example, a user may desire to simultaneously view a first program while recording a second and a third program. In such cases, the program content transporter 200 may receive and communicate program content portions corresponding to a third program, such as program content portion 204c of Program 3 in the illustrated example, to the program store 202. The number of programs that may be concurrently transported by the program content transporter 200 may be based upon various factors, such as the number of programs being concurrently communicated to the program content transporter 200, the hardware characteristics of the program content transporter 200 and/or supporting devices (e.g., processor throughput, storage device throughput, etc.), and the like.

Although one example embodiment has been described with reference to performing operations such as presenting and recording communicated program content, other operations may be facilitated by the program content transporter 200. For example, multiple programs may be concurrently presented, such as via a screen-within-screen functionality provided by a receiving device 118 and/or a presentation device 120. In addition, other target devices may be supported. For example, the program content transporter 200 may communicate received program content to a network interface, for purposes such as communicating the received program content to a personal computer on a home network.

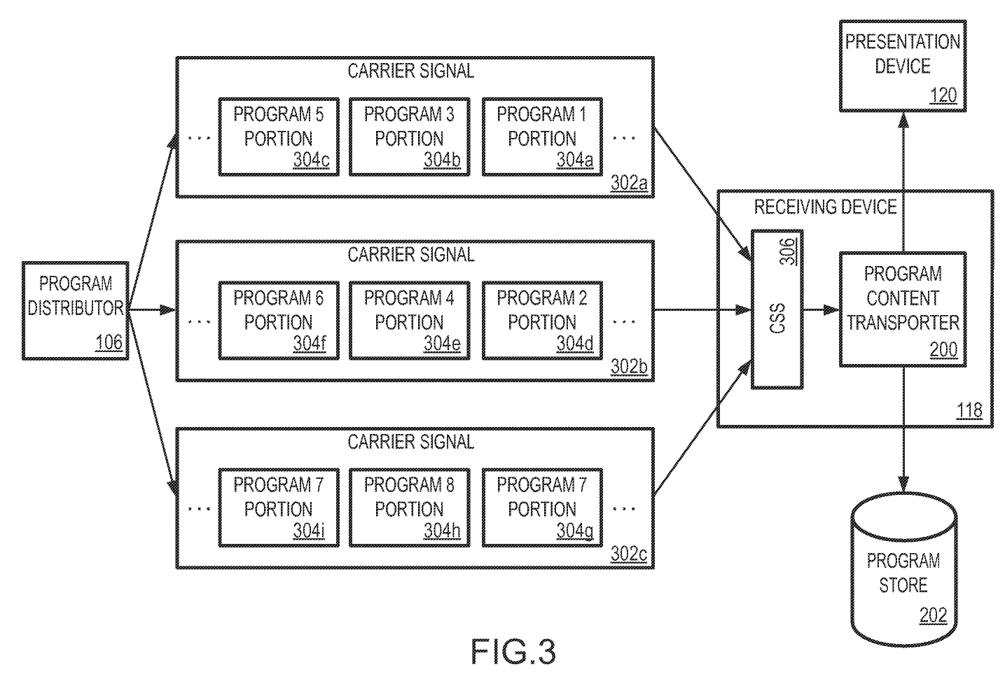

FIG. 3 is a block diagram illustrating multiple programs multiplexed on multiple distinct carrier signals in an example embodiment. In particular, FIG. 3 shows a program distributor 106 communicating eight distinct programs (Programs 1 through 8) to a program content transporter 200 implemented as part of a receiving device 118. The illustrated receiving device 118 includes the program content transporter 200 as well as a content stream selector (“CSS”) 306. In one example, the content stream selector 306 includes a tuner that is configured to tune to a particular frequency that is used to carry programming from the program distributor 106 to the receiving device 118. In addition, the content stream selector 306 may include other components, such as a demodulator, a demultiplexer, and the like. As noted above, the program distributor 106 may communicate programs over a variety of media and/or communication devices, such as one or more of a satellite network, cable network, telephony network, fiber network, terrestrial broadcast network, and the like. Accordingly, in other embodiments, a content stream selector 306 may comprise some other type of communication device or module, such as an Ethernet interface, a cable modem, a USB (“Universal Serial Bus”) port, a serial port, and the like.

In one example, the eight programs are communicated by the program distributor 106 via three distinct carrier signals 302a-302c to the program content transporter 200. More specifically, Programs 1,3, and 5 are communicated via carrier signal 302a, as illustrated by program content portions 304a-304c; Programs 2, 4, and 6 are communicated via carrier signal 302b, as illustrated by program content portions 304d-304f; and Programs 7 and 8 are communicated via carrier signal 302c, as illustrated by program content portions 304g-304i. In a satellite broadcast network embodiment, the three distinct carrier signals 302a-302c may each correspond to a respective satellite transponder frequency. In a cable broadcast network embodiment, the three distinct carrier signals 302a-302c may each correspond to a respective transmission frequency on the cable network.

As noted, in some embodiments, the program transporter 200 may only be capable of receiving program content via a limited number of carrier signals, based at least in part on the capabilities of the content stream selector 306. For example, if the content stream selector 306 includes only a single tuner, it may only be capable of continuously receiving programming from a single carrier signal during a given time period, such that the program content transporter 200 may only be capable of concurrently processing programming carried on that carrier signal during the time period.

In one example, if a user elects to view Program 1 and record Program 5, the content stream selector 306 may be adapted to tune to carrier signal 302a, such that the program content transporter 200 can concurrently process the program content portions corresponding to Program 1 and Program 5 by respectively communicating content from program content portion 304a to the presentation device 120 and communicating content from program content portion 304c to the program store 202. However, if a user elects to view Program 1 and record Program 2, the content stream selector 306 may only be able to tune to either carrier signal 302a or carrier signal 302b, such that concurrently processing Program 1 and Program 2 may not be possible.

Given a receiving device 118 having a content stream selector 306 that cannot concurrently receive program content from more than one carrier signal, an improved user experience may be provided by intelligently grouping programs that are communicated on each carrier signal. In particular, the program distributor 106 may group programming by carrier signal, such that programs that are commonly concurrently processed are communicated via a single carrier signal. Such grouping may be based on various factors, including the characteristics of the carrier signal (e.g., bandwidth capacity), the characteristics of each program (e.g., bandwidth utilization, program category, and the like), and/or the historical operation of one or more receiving devices. For example, the program distributor 106 may obtain information regarding sets of programs that are frequently the subject of requests for concurrent processing. Such information may be obtained in a variety of ways, such as via some “upstream” or “backchannel” communication link between the receiving device 118 and the program distributor 106, such as an Internet Protocol (“IP”) connection provided by a telephony link between the receiving device 118 and the program distributor 106. Given such information, the program distributor 106 may determine that particular sets of programs are commonly the subject of requests for concurrent processing, and accordingly communicate the programs of each of those sets of programs together on a corresponding carrier signal.

In some embodiments, the program distributor 106 may group additional programming on a given carrier signal by utilizing residual bandwidth to communicate one or more additional programs. For example, given a carrier signal that provides 30 Mbits/s capacity, and program content streams that each consume four Mbits/s, a program distributor 106 would ordinarily be able to group eight program content streams on the carrier signal, resulting in two Mbit/s underutilization of the carrier signal. However, the program distributor 106 may elect to include at least one additional, lower-bandwidth program that may be of interest to viewers of at least one of the eight programs being communicated via the carrier signal. For example, if a feature film is being communicated as one of the programs, a related program, such as a documentary about the making of the film, or an alternate ending to the film, may be communicated as the additional, lower-bandwidth program. Then, users may elect, or the receiving device 118 may automatically determine, to record the related program so that they can view it after viewing the film. Note that in some situations, the additional program need not be communicated in or about real time, provided that it is recorded to be watched after the viewing of some other program. In some embodiments, multiple additional programs may be concurrently recorded or otherwise utilized while a first program is being presented. For example, advertising content and a news program may be communicated via residual bandwidth of a carrier signal, and the advertising content and the news program may be recorded for later presentation while a selected program is being received via the carrier signal and presented on a presentation device. Various types of additional programming are contemplated for communication, including documentaries, interactive programming, advertising/commercials, director/actor commentaries, software modules and/or updates (e.g., for execution on the receiving device 118), program information (e.g., program content stream description tables, program scheduling information for an electronic program guide, etc.), and the like.

Note that additional programming communicated via residual bandwidth on one or more carrier signals need not be related to any particular programming being communicated on the carrier signals. For example, in some embodiments, the residual bandwidth on a plurality of carrier signals may be utilized to provide a video-on-demand (“VOD”) service. For example, the carrier signals 302a-302c may each have a quantity of residual bandwidth. The residual bandwidth on each of carrier signals 302a-302c may be utilized to continuously communicate one or more VOD programs, such as feature films. One or more of the VOD programs may then be recorded by the program content transporter 200 on the program store 202. This recording process may occur even when the receiving device 118 is not being actively utilized by a user, such as when the device is “asleep” and not presenting any programming via a presentation device 120. Overtime, the receiving device 118 can accumulate a collection of one or more complete VOD programs on the program store 202, such that the stored VOD programs can be made available for viewing to a user.

Note also that identical programming may be communicated via residual bandwidth of a plurality of carrier signals. For example, in the context of the video-on-demand example described above, an identical set of one or more VOD programs may be communicated on the residual bandwidth of each of a plurality of carrier signals. In other embodiments, identical sets of one or more advertisements or commercials, instructional programming, news programs, program information, and the like may be communicated on the residual bandwidth of each of a plurality of carrier signals.

In addition, programs communicated via carrier signals 302a-302c may consume varying amounts of bandwidth. For example, some programs may consume lower amounts of bandwidth due to various factors, such as properties or characteristics of the programming. For example, higher compression rates may be achieved for some types of programming, such as those with substantially static images or scenes, resulting in lower bandwidth utilization for such programming and a corresponding increase in residual bandwidth for a given carrier signal. In such situations, the program distributor 106 may elect to dynamically increase the amount and/or bandwidth of additional programming communicated via the residual bandwidth of the carrier signal. For example, the program distributor 106 may monitor the amount of residual bandwidth available on a given carrier signal, and as sufficient bandwidth becomes available, increase the transmission rates of additional programming being currently communicated via the carrier signal and/or begin to communicate one or more other additional programs via the carrier signal.

C. Receiving Device Overview

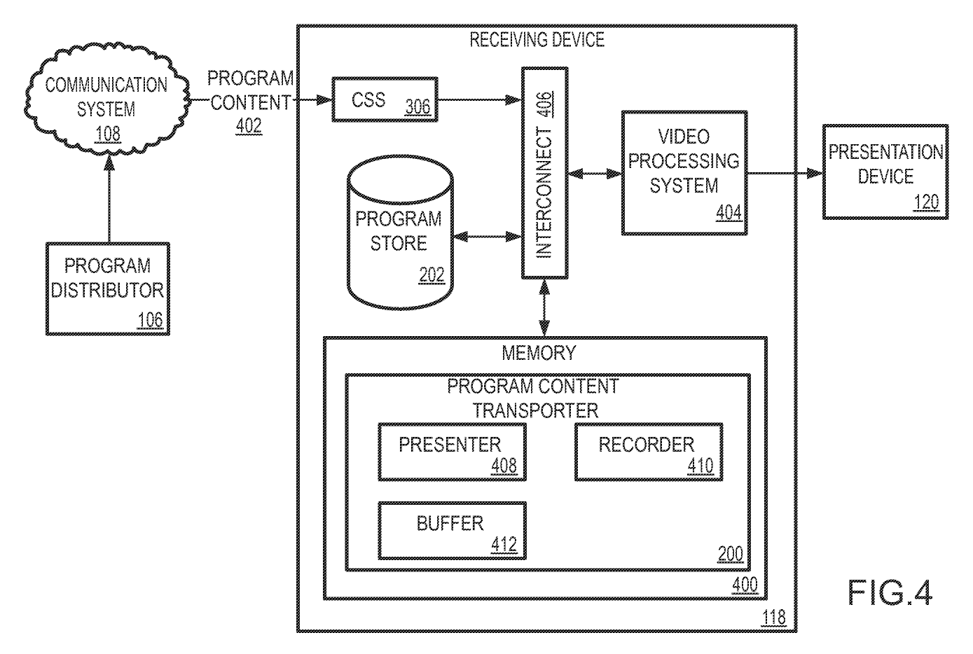

FIG. 4 is a block diagram illustrating an example embodiment of a program content transporter 200 implemented in a receiving device 118. In the illustrated example, the receiving device 118 comprises a memory 400, a program store 202, a video processing system 404, a content stream selector 306, and an interconnect 406. The memory 400, program store 202, video processing system 304, and content stream selector 306 are communicatively coupled to one another via the interconnect 406. The memory 400 includes a program content transporter 200 comprising a presenter 408, a recorder 410, and a buffer 412. Other devices, components, and/or logic that are not illustrated may also be included in the receiving device 118.

The receiving device 118 receives program content 402 from the program distributor 106 via the communication system 108. As discussed above, the program content 402 may include multiplexed video, audio, and/or data corresponding to one or more programs communicated as a series of program content portions as described with reference to FIGS. 2 and 3, above.

The program content transporter 200 facilitates the concurrent processing of two or more programs. For example, when a user directs the receiving device 118 to concurrently present a first program and record a second program, the program content transporter 200 directs the content stream selector 306 to obtain program content portions corresponding to the first and second program. In response, the content stream selector 306 begins to deliver program content portions corresponding to the first and second programs to the buffer 412 via the interconnect 406. In addition, the program content transporter 200 initiates the concurrent operation of the presenter 408 and the recorder 410. The presenter 408 and recorder 410 may be software modules (e.g., functions, threads, processes) that may execute concurrently on, for example, the video processing system 404 or some other processor(s).

The presenter 408 consumes program content portions corresponding to the first program from the buffer 412 and communicates those program content portions via the interconnect 406 to the video processing system 404 for presentation on the presentation device 120. The video processing system 404 and/or the presenter 408 may perform additional processing on program content portions, such as decompression, decryption, encryption, scaling, and the like, prior to communicating the program content to the presentation device 120.

The recorder 410 consumes program content portions corresponding to the second program from the buffer 412 and communicates them via the interconnect 406 to the program store 202. For example, if the program store 202 is a hard disk, the recorder 410 may initiate disk writes of the program content portions to the hard disk. The recorder 410 may perform additional processing on program content portions, such as decompression, decryption, encryption, scaling, and the like, prior to communicating the program content to the program store 202.

The selection of programs that are to be concurrently processed by the program content transporter 200 may occur in various ways. As noted above, in some embodiments a user may direct, such as by selecting the appropriate input elements of an interface to the receiving device 118, the concurrent presenting and recording of two distinct programs. In other embodiments, the program content transporter 200 may automatically determine to record a second program, based on a first program selected for presentation by a user. Such an automatic determination may also be based on a user's viewing habits, such as information about which programs a user has previously requested be concurrently presented and recorded. Such an automatic determination may also be based on other information, such as demographic information about a user and/or currently presented programming. For example, if it is known that a first and second program compete for the same audience, the program content transporter 200 may automatically determine to record the second program if a user elects to view the first program.

Although one example of the program content transporter 200 includes concurrent presenting and recording functionality, other embodiments may contain additional and/or alternative functionality. For example, in some embodiments, the recorder 410 may be configured to concurrently record more than one program to the program store 202. In addition, some embodiments may include a network communicator that is operable to consume received program content and provide it to another network, such as a home network communicatively coupled to the receiving device 118, for communication to some other device, such as a personal computer, personal media player, and the like.

As noted, in some embodiments it may not be possible to concurrently process any two or more arbitrarily selected programs, due to limitations of the content stream selector 306. In such cases, when a user selects two programs that are, for example, carried on distinct carrier signals, the program content transporter 200 may notify the user that such an operation is not possible. In addition, the program content transporter 200 may automatically notify the user of which programs may be concurrently processed based on a selected program, such as by displaying indications of other programs that are carried on the carrier signal corresponding to the selected program. Furthermore, the program content transporter 200 may communicate an indication of received requests for concurrent program utilization to the program distributor 106, such that the program distributor 106 can gather information about programs that are frequently the subject of requests for concurrent processing, for purposes of improving the assignment of programs to particular carrier signals.

In the illustrated example embodiment, the program content transporter 200 is implemented primarily in software. In particular, the presenter 408 and the recorder 410 comprise software modules containing instructions that, when executed, perform at least some of the functions of the program content transporter 200. The video processing system 404 includes a processor that is configured to execute the instructions, and process the data, of the program content transporter 200.

Furthermore, in some embodiments, some or all of the components of the program content transporter 200 may be implemented or provided in other manners, such as at least partially in firmware and/or hardware, including, but not limited to one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), and the like. Some or all of the system components and/or data structures may also be stored (e.g., as software instructions or structured data) on a computer-readable medium, such as a hard disk, a memory, a network, or a portable media article to be read by an appropriate drive or via an appropriate connection. The system components and data structures may also be transmitted via generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

The program content transporter 200 may be implemented and/or structured in various other ways. In particular, the functions of the program content transporter 200 may be performed by a different arrangement of components and/or modules of the receiving device 118, including a greater or lesser number of components. For example, the presenter 408 and the recorder 410 may be implemented as a single software module, rather than two distinct modules as illustrated.

D. Processes

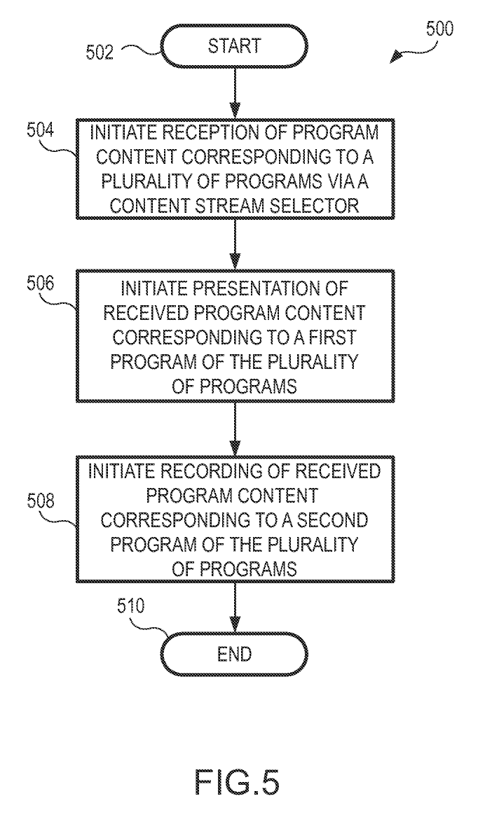

FIG. 5 includes a flowchart of process 500, used by an embodiment of a program content transporter. In this regard, the described process may represent a module, segment, or portion of code, which comprises one or more executable instructions for implementing the specified logical function(s). It should also be noted that in some implementations, the functions noted in the process may occur in a different order, may include additional functions, may occur concurrently, and/or may be omitted.

FIG. 5 is a flow diagram of an example program content transporter process 500 provided by an example embodiment. The process 500 may be implemented by, for example, but not limited to, one or more hardware, firmware, and/or software modules, components, and/or devices, such as are illustrated in the receiving device 118 described with reference to FIG. 4, such as the program content transporter 200, the presenter 408, the recorder 410, and/or the video processing system 404.

The process 500 starts at 502. At 504, the process initiates reception of program content corresponding to a plurality of programs via a single content stream selector. For example, the content stream selector may comprise a single tuner, and the program content transporter may direct the content stream selector to tune to a frequency of a carrier signal that carries multiple program content streams multiplexed in a manner as described above. The content stream selector may then begin and continue to receive and forward, such as by storing in a buffer 412, program content portions from each of the multiple program content streams, as they arrive over the carrier signal.

At 506, the process initiates presentation of received program content corresponding to a first program of the plurality of programs. Initiating presentation of received program content may include initiating or starting a thread or process, such as illustrated by presenter 408, operable to continuously consume program content portions corresponding to the first program and forward them for purposes of presentation, such as by providing them to a video processing system 404. The video processing system 404 may then, in turn, provide the program content of the program content portions to a presentation device 120.

At 508, the process initiates recording of received program content corresponding to a second program of the plurality of programs. Initiating recording of received program content may include initiating or starting a thread or process, such as illustrated by recorder 410, operable to continuously consume program content portions corresponding to the second program and forward them for purposes of storage, such as by initiating a appropriate storage operation on a program store 202.

At 510, the process ends. In some embodiments, the process may perform various cleanup operations prior to terminating, such as waiting for the presenter 408 and/or the recorder to 410 to terminate, notifying other components of termination status, providing indications of the two programs concurrently presented and recorded to a program content distributor 106, and the like.

The process 500 is described as utilizing three concurrently executing processes. In particular, the process 500 utilizes a receiver process that obtains program content portions from a single carrier signal, a presenter process that consumes obtained program content portions corresponding to a first program and forwards those program content portions for presentation, and a recorder process that consumes obtained program content portions corresponding to a second program and forwards those program content portions for recording. Additional processes may be also or instead be utilized for various purposes, such as concurrent viewing of multiple programs (e.g., by initiating a second presentation process, configuring the existing presentation process to handle additional programs, and the like), concurrent recording of multiple programs (e.g., by initiating a second recording process, and the like), alternative disposition of one or more programs (e.g., communication to some other device or destination via a network), and the like.

In addition, although the process 500 is describes as utilizing three independent concurrent processes, it may be structured in other ways. For example, other concurrency techniques and/or abstractions may be utilized, including tasks, kernel threads, user threads, and the like. Further, the various described processes may communicate using various inter-process communication primitives, such as via pipes, messages, sockets, and the like. In another embodiment, the process 500 may be structured as a single routine that utilizes, for example, non-blocking input/output primitives to transport incoming program content.

While various embodiments have been described hereinabove, it is to be appreciated that various changes in form and detail may be made without departing from the spirit and scope of the invention(s) presently or hereafter claimed.

1. A system that concurrently processes multiple distinct programs communicated via a single carrier signal, the system comprising:
a receiving device comprising:
a tuner operable to receive a multiplexed signal via a satellite network that communicates digital video programming, the multiplexed signal comprising a plurality of program content portions, each program content portion corresponding to one of a plurality of programs; and
a program content transporter communicatively coupled to the tuner, the program content transporter operable to:
determine a first and second program of the plurality of programs; and
concurrently present the program content portion corresponding to the first program on a display device communicatively coupled to the receiving device and record the received program content portion corresponding to the second program.

2. The system of claim 1 wherein the receiving device is a set-top box, wherein the single tuner is operable to receive program content from only one carrier signal at a time, and wherein the second program is not transmitted in real time.

3. The system of claim 1, further comprising:
a program distributor system communicatively coupled to the receiving device, the program distributor system operable to:
select the plurality of programs based at least in part on whether at least some of the plurality of programs are commonly concurrently processed by receiving devices; and
transmit the multiplexed signal to the receiving device.

4. The system of claim 3 wherein the program distributor system is further operable to select one or more additional programs based at least in part on an amount of residual bandwidth that is provided by the single carrier signal that is not utilized by the plurality of programs, and based at least in part on content of at least one of the plurality of programs.

5. The system of claim 4 wherein one of the one or more additional programs is the second program and includes content that is related to content of the first program.

6. The system of claim 4 wherein the residual bandwidth is insufficient to transmit at least one of the one or more additional programs in real time.

7. The system of claim 1 wherein the satellite network communicates video programming via a plurality of carrier signals that each include residual bandwidth that is utilized to transmit one or more additional programs in non-real time.

8. The system of claim 1, further comprising a storage device communicatively coupled to the program content transporter, and wherein the program content transporter is operable to store on the storage device program content from the program content portion corresponding to the second program.

9. A method to concurrently process multiple distinct programs communicated via a single carrier signal, the method comprising:
receiving via a content stream selector in a receiving device a multiplexed signal that contains a plurality of program content portions that each correspond to one of a plurality of programs, the multiplexed signal received by the receiving device via a broadcast network that communicates digital video programming;
presenting a first program content portion of the received program content portions, the first program content portion corresponding to a first program of the plurality of programs; and
recording a second program content portion of the received program content portions, the second program content portion corresponding to a second program of the plurality of programs, wherein the presenting of the first program content portion and the recording of the second program content portion are performed concurrently.

10. The method of claim 9 wherein the receiving device is a set-top box, and wherein the content stream selector is operable to receive program content from only one carrier signal at a time.

11. The method of claim 9 wherein the content stream selector comprises a tuner.

12. The method of claim 9 wherein the receiving via the content stream selector the multiplexed signal that contains the plurality of program content portions comprises demultiplexing the multiplexed signal to obtain program content portions corresponding to the first program and to the second program.

13. The method of claim 9 wherein the presenting of the first program content portion comprises forwarding program content contained in the first program content portion to a display device, and wherein the recording of the second program content portion comprises storing program content contained in the second program content portion on a program store.

14. The method of claim 9 wherein the receiving the multiplexed signal includes receiving content portions corresponding to the second program at less than real time.

15. The method of claim 9 further comprising, initiating the execution of multiple concurrent processes, wherein a first concurrent process of the multiple processes performs the receiving via the content stream selector the multiplexed signal, a second concurrent process of the multiple processes performs the presenting of the first program content portion, and a third concurrent process of the multiple processes performs the recording of the second program content portion.

16. The method of claim 9 further comprising, automatically determining to record the second program based at least in part on the first program and/or viewing habits of a user.

17. The method of claim 9 further comprising:
receiving from a user a request to record a third program that is not one of the plurality of programs; and
notifying the user that the third program cannot be recorded.

18. The method of claim 9 wherein the broadcast network includes at least one of a satellite network and a cable network.

19. The method of claim 9 wherein the second program corresponds to one of multiple video on demand programs being communicated by the broadcast network via residual bandwidth of the multiplexed signal.

20. A computer-readable medium whose contents enable a receiving device to concurrently process multiple distinct programs, by performing a method comprising:
receiving via a content stream selector a multiplexed signal that contains a plurality of program content portions that each correspond to one of a plurality of programs, the multiplexed signal received from a broadcast network that communicates digital video programming, a first program of the plurality of programs communicated in or about real time via the multiplexed signal, a second program of the plurality of programs not communicated in real time via the multiplexed signal; and
concurrently presenting the received program content portion corresponding to the first program of the plurality of programs and recording the received program content portion corresponding to the second program of the plurality of programs.

21. The computer-readable medium of claim 20 wherein the computer-readable medium is at least one of a memory in a computing device or a data transmission medium transmitting a generated signal containing the contents.

22. The computer-readable medium of claim 20 wherein the contents are instructions that when executed cause the computing system to perform the method.
